(19) United States
(12) Patent Application Publication
(10) Pub. No.: US 2009/0292578 A1
(43) Pub. Date: Nov. 26, 2009

(54) Articulation Workload Metrics

(76) Inventors: Catalina Maria Danis, Hastings-on-Hudson, NY (US); Brenda Lynn Dietrich, Yorktown Heights, NY (US); Thomas David Erickson, Minneapolis, MN (US); Pia T. Gospodinoff, Ledyard, CT (US); Mary Elizabeth Helander, North White Plains, NY (US); Wendy Anne Kellogg, Yorktown Heights, NY (US); Jurij Rostyslav Paraszczak, Pleasantville, NY (US); Rhonda Rosenbaum, Millwood, NY (US)

Correspondence Address: F. CHAU & ASSOCIATES, LLC, 130 WOODBURY ROAD, WOODBURY, NY, 11797, US

(21) Appl. No.: 12/123,743

(22) Filed: May 20, 2008

(51) Int. Cl. G06Q 10/00

(52) U.S. Cl. 705/9; 705/7; 705/11

(57) ABSTRACT

A method for determining an allocation of a workload includes identifying an employee in an organization having the workload, associating the employee with an articulation workload metric, and determining the allocation of the workload to the employee according to the articulation workload metric.

### BACKGROUND

1. Technical Field

The present invention relates to measuring the workload of the employees, and particularly the managers and executives (henceforth called ‘principals’), of an organization.

2. Discussion of Related Art

Administrative assistants are typically employed as assistants to principals in large organizations. As assistants, they perform a variety of tasks on behalf of their principals, both carrying out requests made of them by their principals, as well as handling requests directed to their principals.

The work of administrative assistants is little studied, and is typically viewed as routine. However, research in the social sciences has shown that seemingly routine tasks are often surprisingly complex, fraught with errors and exceptions that require considerable local and technical knowledge to rectify.

A closer examination of the work performed by administrative assistants shows that much of it can be classified as ‘articulation work.’ Articulation work is the work necessary to do work. This includes the work necessary to prepare to do a task, the work necessary to “clean up” after a task, and the work involved in switching between tasks. In more detail, articulation work in support of preparing to do a task includes scheduling related tasks, such as arranging who is to do what, and when, where, and how they are to do it. Articulation work related to carrying out a task includes assembling and laying out the resources necessary to complete a task, and creating and maintaining plans, schedules, and other artifacts that aid in carrying out work and conducting meetings.

The work of principals includes articulation work but is differentiated from the work of assistants by having a focus on making decisions about strategy, funding and resources, being a liaison and performing cross-organizational coordination (e.g., relationship management responsibilities), as well as contributing to project directions. The primary work of principals is often termed ‘knowledge work.’ In their role as knowledge workers, principals generate and receive streams of requests, including requests for meetings, presentations, opinions, resources, and decisions. Some of these requests are routine and can be anticipated. Other requests arise due to non-routine events and need to be dealt with as they occur. Regardless of how routine the requests, they vary in urgency and importance.

What the administrative assistant does with incoming requests depends on a variety of factors, such as the urgency of the task and the principal's priorities. Administrative assistants, by virtue of an understanding of their principals' needs, schedules and tasks, serve as filters and pre-processors, transforming a broad flow of information and communication into a more coherent stream that enables principals to have what they need to function effectively on hand at the moment they need it. Administrative assistants may also handle tasks initiated by the principal, or assist the principal in delegating and scheduling those tasks.

In view of the foregoing, it can be seen that articulation work, created by principals and performed by administrative assistants, is valuable to the organization. Due to variations in the nature, role and responsibilities of principals, articulation work, and thus the administrative support needed to perform the articulation work, varies. Quantifying articulation work is therefore important. However, there exists no method for measuring or analyzing articulation work.

Therefore, a need exists for a method for determining an allocation requirement for assigning articulation work.

### BRIEF SUMMARY

According to an embodiment of the present disclosure, a method for determining an allocation of a workload includes identifying an employee in an organization having the workload, associating the employee with a partial articulation workload metric, and determining the allocation of the workload to the employee according to the partial articulation workload metric.

According to an embodiment of the present disclosure, a method for determining an allocation of a workload includes identifying an employee in the organization having the workload, associating the employee with an articulation workload metric, and determining the allocation of the workload to the employee according to the articulation workload metric.

According to an embodiment of the present disclosure, a method for determining an allocation requirement for assigning articulation work includes collecting work artifacts for each of a plurality of employees, recovering input data from the work artifacts, observing collaborative artifacts from the input data, creating a partial articulation workload metric for each employee from the input data and the collaborative artifacts, creating a direct collaboration network for each employee including a respective employee and a list of unique collaborators relative to the respective employee observed based on the collaborative artifacts, creating an overlay network from the collaborative artifacts of each employee, weighting nodes of the overlay network based on the partial articulation workload metrics of each employee, deriving a node articulation workload metric associated with each node of the overlay network, and converting the node articulation workload metric into the allocation requirement for assigning articulation work.

According to an embodiment of the present disclosure, a method for determining a node articulation workload metric includes collecting work artifacts for each of a plurality of employees, recovering input data from the work artifacts, observing collaborative artifacts from the input data, creating a partial articulation workload metric for each employee from the input data and the collaborative artifacts, creating a direct collaboration network for each principal including a respective principal and a list of unique collaborators relative to the respective employee observed based on the collaborative artifacts, creating an overlay network from the partial articulation workload metrics of the employees, weighting nodes of the overlay network based on the partial articulation workload metrics, and deriving the node articulation workload metric associated with each node of the overlay network.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a diagram of areas of work for an articulation worker according to an embodiment of the present disclosure;

FIGS. 2A-B is a flow chart of a method for allocating articulation workers according to an embodiment of the present disclosure;

FIG. 3A is a graph of a direct collaboration network according to an embodiment of the present disclosure;

FIG. 3B is a graph of a combined (overlay) network according to an embodiment of the present disclosure;

FIG. 4 is a graph showing a conversion of a metric value to an allocation amount (range) based on a function; and

FIG. 5 is a diagram of a computer system for executing instructions for performing a method according to an embodiment of the present disclosure.

### DETAILED DESCRIPTION

According to an embodiment of the present disclosure, a model of the work of assistants is created that illustrates the ways in which they act as articulation workers. Of particular note is the importance of principals' collaborations, assistants' relationships with other assistants (e.g., in scheduling meetings), and the degree of autonomy that their deep knowledge of their principals' priorities and tasks enables.

Quantitative analyses are provided for principals' calendars and for communication among assistants gleaned from analysis of their email and instant messaging. Here the methods and tools used, and a model of the assistants' communication network are described. The exemplary results discussed herein are based on semi-structured interviews with various employees having the role of assistant or principal.

An exemplary model of work includes a principal, a stream of incoming and outgoing requests to be handled, a plan for each request, target collaborators for each request, and tracking and accounting for each request.

The principal is faced with a constant stream of requests of varying urgency and importance. Requests could be generated by other people (collaborators, subordinates, superiors, etc) or as a result of the principal's own role, for example being a relationship manager and needing to meet regularly with another organization for which the principal is a liaison.

For the stream of requests to be handled, requests directed to or from the principal can be categorized as: those which are urgent and must be dealt with “now;” those which are less urgent (e.g., anticipated) and can be scheduled for “the future;” and incoming requests that need never be dealt with, which can be refused.

For each request that is to be dealt with, there also needs to be a decision about how it is to be dealt with: this includes who is to deal with it; the plan and what, if any, preparations need to be made to support the plan, and actions incumbent on the assistant, the principal and/or the principal's staff.

Each request generates a set of tasks and activities, such as further data collection, coordination with collaborators of the principal, coordination with related requests, negotiation with others on behalf of the principal's interest, etc.

For each request that has been handled, it is often useful for its progress to be tracked, for its outcome to be recorded, and for the resources consumed (e.g., expenses) to be accounted for.

Although reality can be more complex, this description is sufficient to structure the nature of an assistant's work.

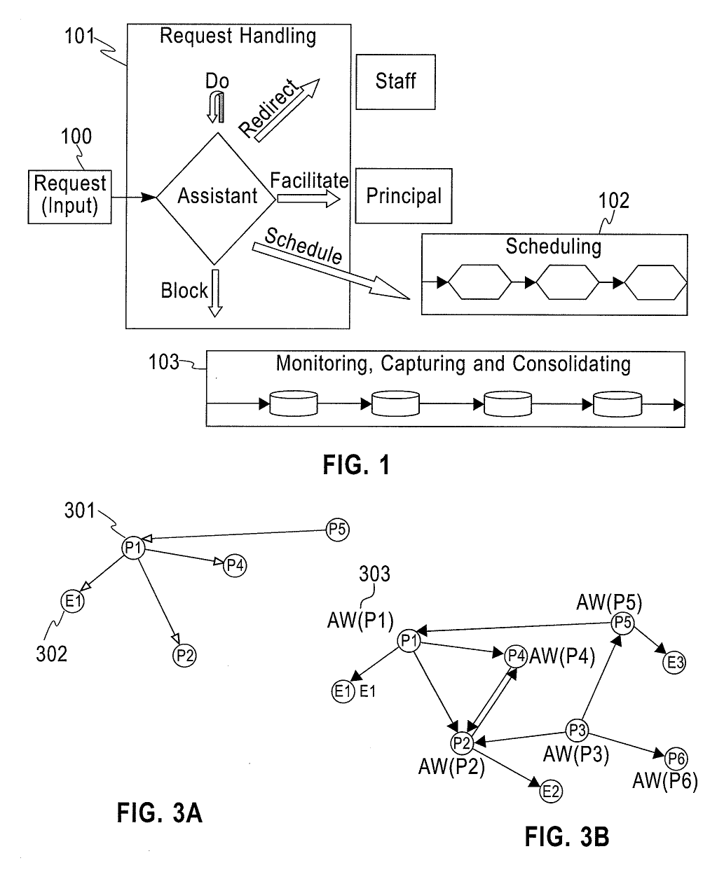

FIG. 1 shows the model of the role of the assistant. The figure depicts roles relative to the assistant. The assistant is a gate keeper for the principal, receiving requests. The assistant is an implementer for the principal, generating requests of others and gaining commitments from them. This is most applicable to the case of the assistant supporting a single principal.

Requests 100 are received from, for example, the principal, collaborators, or others. The assistant has areas of work including two-way request handling 101, scheduling 102 and monitoring, capturing and consolidating 103, and executing in a manner consistent with the strategy and tactics defined by the roles and responsibilities of the principal.

The efficiency of the administrative assistant to perform articulation work for a principal depends on the assistant's own experience, understanding of the principal's work and work style preferences, and the assistant's own network of collaborators among those people who perform articulation work for principals who are collaborators with the principal being supported.

Referring to request handling 101; the requests are for the principal's time and energy. What an assistant does with the incoming requests depends on a variety of factors such as the urgency of the task and the principal's priorities.

The first type of request handling is for the assistant to completely handle the request. A second type of request handling is redirection, wherein the assistant may redirect a request to another staff member of the principal. Another role assistants play is in facilitating the handling of requests (e.g., ensuring that timely responses from staff are made). Another form of request handling is to block the request.

Referring to scheduling 102, scheduling involves knowing which processes meetings are part of, what preparations must be made, knowing who needs to participate, and negotiations with other assistants to arrive at a time for the meeting.

One part of scheduling a meeting is understanding whether and what type of preparations the principal will need. Another aspect of scheduling a meeting is making the time for it. Principals' calendars are often tightly scheduled, and scheduling a meeting may include distinguishing key participants among all invitees and rescheduling one or more other meetings so that all key participants can attend.

Referring to monitoring, capturing and consolidating 103; in tandem with request handling 101, the assistant performs monitoring of what is happening, capturing relevant bits of status and history, and pulling together information related to a particular task so that, when the principal takes it up again, all (and only) the needed material will be at hand. Monitoring is most frequently and completely carried out when an assistant is supporting a single principal. Assistants monitor calendars, tasks, communications, etc. Assistants capture and consolidate information for the use of their principals. The capture and consolidation enable principals to move quickly and effectively from one task to another. The monitoring enables the principal to avoid unnecessary communication such as forwarding a note to the assistant to have it acted on.

According to an embodiment of the present disclosure, allocation amounts are based on a complexity metric derived from collaborative work artifacts. One example of a collaborative work artifact is a calendar event, historical or projected into the future. The method is relatively immune to gaming because the complexity metric is based on a principal's entire network.

Complexity may be measured according to scheduled utilization (e.g., percentage of time the calendar owner is engaged in scheduled meetings, appointments, and all day events), engaged utilization (e.g., scheduled utilization excepting multiple bookings), free time utilization (percentage of time during local business hours that is unscheduled), fragmentation (free time intervals), concentration (duration of meetings and appointments), collaboration index (how many attendees do meetings involve), accommodation index (scheduling outside of business hours), number of business trips, percentage of time spent travelling, proportion of foreign travel to overall travel, types, number and nature of key collaborators, and primary responsibility or ongoing joint responsibilities. The metric may include further measures of complexity such as a globalization index (attendees from other time zones), an external index (meetings including attendees from outside the company), churn (rescheduling), availability (difficultly of scheduling a new meeting of one hour duration in the next three business days), flexibility (alternatives for rescheduling any given meeting into an available (business base) timeslot within the next five business days), and volume (how many meetings, appointments, all day events over a given time period). One of ordinary skill in the art would recognize that other metrics of complexity may be implemented.

Turning now to the scheduled utilization by way of example; the scheduled utilization metric may be defined as follows:

Type:
Partial Articulation Workload Metric

Value Range: non-negative, real number

Description:
Total scheduled minutes divided by total business base*minutes. May be >1 if a person double, triple, etc books timeslots, and/or is scheduled outside of business base hours.

Interpretation:
Higher values indicate a busy meeting schedule and higher complexity, and thus require more resources to support.

Business Base:
Any time during weekdays between defined local business hours inside the time zone of the calendar owner. Meetings across time zones may also be accommodated.

Another exemplary implementation of a metric is given for the collaboration index, which may be defined as follows:

Type:
Partial Articulation Workload Metric

Value Range:
Nonnegative real numbers

Description:
The [mean, median, mode] number of attendees who co-participate (as required and optional invitees) in a meeting.

Interpretation:
Higher values of the [mean, median, mode] indicate higher complexity, particularly for meetings that are chaired by the principal.

According to an embodiment of the present disclosure a method determines how to assign an available pool of assistants, with given skill requirements, to a set of principals who have allocation needs based on articulation workload.

According to an embodiment of the present disclosure a method may implement a partial articulation workload metric. The partial articulation workload metric is a complexity metric for an individual, based on the individual's own attributes alone, that measures the complexity of their articulation workload based on information derived from artifacts related to their work (e.g., calendar) as well as individual characteristics such as role, rank, key collaborators, travel profile, etc., and collaboration network characteristics.

According to an embodiment of the present disclosure a method may implement an articulation workload metric. The articulation workload metric is a complexity metric for an individual, based on the individual's attributes plus those of direct and indirect collaborators (which can be modeled via a “social network”), that measures the complexity of their articulation workload—e.g., a characteristic of a node (individual, calendar owner) that takes information about position and structure of the entire collaboration network into account.

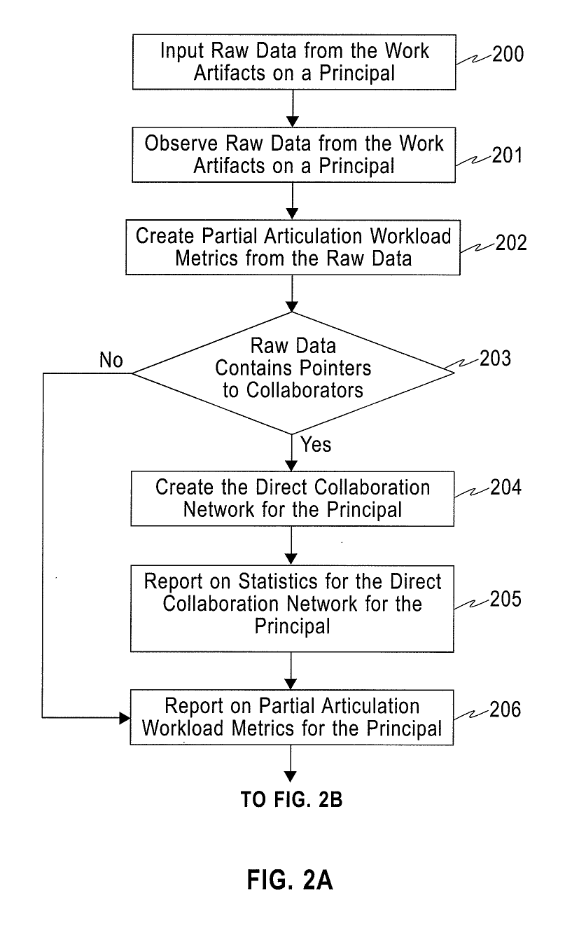

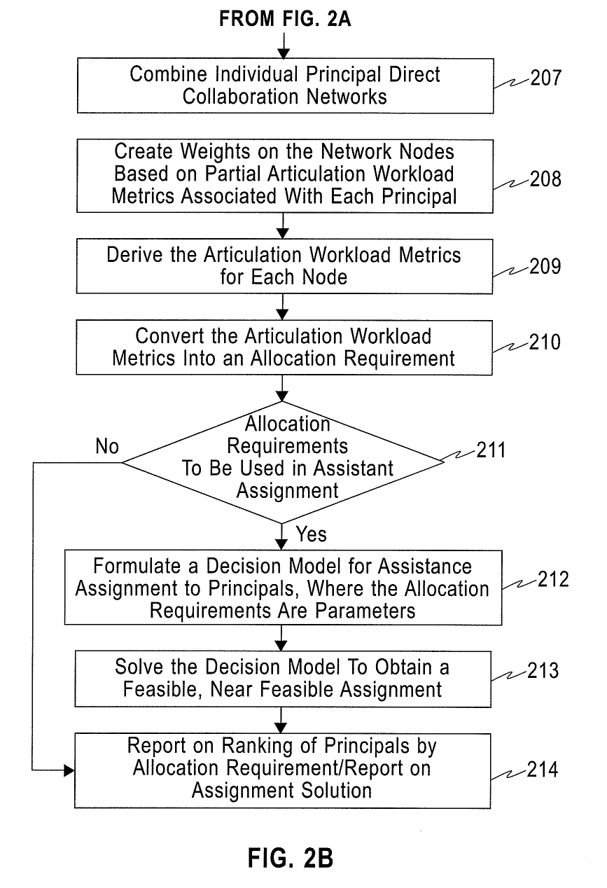

Using the partial articulation workload metric and the articulation workload metric as complexity metrics, resource allocation requirements may be determined. For example, as depicted in FIG. 2A, a method for allocating articulation resources includes recovering input data from work artifacts, such as principal calendar entries: past history and forward projections, on a principal 200—the flow of FIG. 2A is performed for each individual or member of a target population to be included in an articulation workload metric. The target population is a reference set, including any connections found in a direct collaboration network of principals analyzed. The process of considering new principals can continue until a stopping rule is met, for example, consider the entire target population or all members of the target population within a predetermined distance in a network from the principal. Collaborative artifacts are observed from the input data 201. The work artifacts include raw information that describes work events, both historic and future. The raw information may include pointers to collaborators (e.g., members of the target population). An example of a work artifact is a Lotus Notes calendar. An example of raw data recovered from the work artifact includes a meeting, together with its details, such as type, attendees, location, time, chair, etc. A partial articulation workload metric is created from the input data 202. The partial articulation workload metric includes, for example, the number of meetings, mean and variance of meeting duration, utilization during normal working hours, utilization outside of normal working hours, percentage on conference calls, percentage in person, percentage requiring travel, number requiring scheduling revisions (1, 2, 3, . . . ), number of unique collaborators, etc. An individual direct collaboration network (see for example, FIG. 3A) is created from principal's (“P” e.g., 301) list of unique collaborators (“E” e.g., 302) 204, which includes the collaborators of the principal, together with attributes of each collaborator. A report may be generated including statistics for the direct collaboration network of the principal 205, for example, including a number of external collaborators. The partial articulation workload metric for the principal is reported 206.

For raw data that does not include pointers to collaborators, as determined at block 203, a partial articulation workload metric may be generated 206 directly.

FIG. 3B is an example of a combined (overlay) network of all collaborators (see block 204), and an AWM 303 (articulation workload metric) for each node (principal)−a partial articulation workload metric (see block 202). AW(Pi)=articulation workload metric associated with node Pi. The AW(Pi) values are entries of the dominant eigenvector of the modified adjacency matrix weighted by the PAW(Pi) values. The metric value is converted to an allocation amount based on a function, e.g., calibrated from historical data and expert opinion.

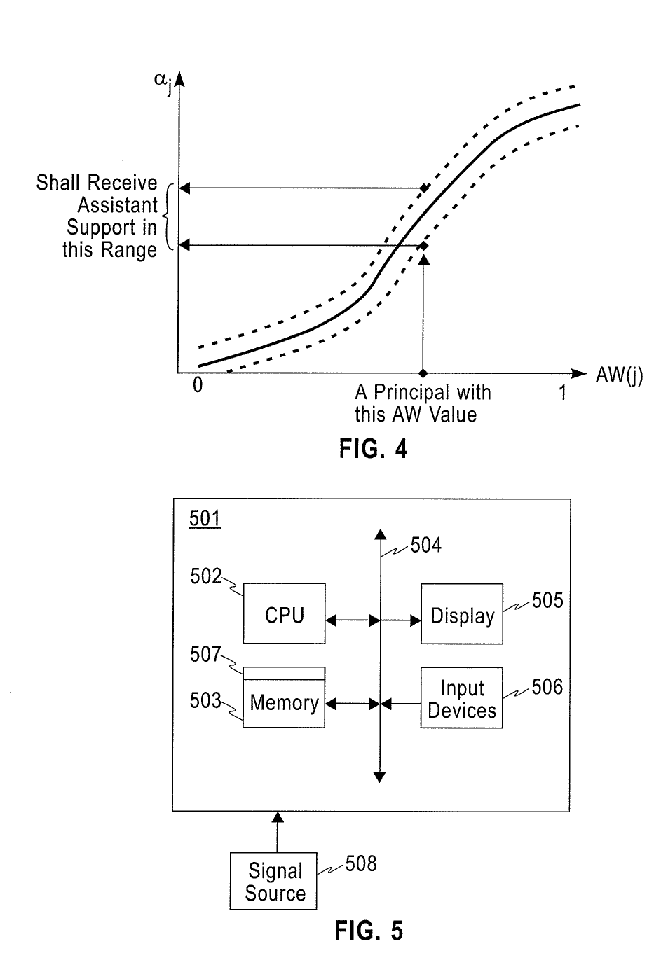

Referring to FIG. 2B, the individual principal direct collaboration networks are combined 207 and weights on network nodes of the combined network are created based on partial articulation workload metrics associated with each principal 208. This may be a convex combination or another weighted combination. Articulation workload metrics are derived at each node 209, wherein a node's position in the network is taken into consideration, for example, using an Eigenvalue analysis. The articulation workload metrics are converted into an allocation requirement 210 (see FIG. 4).

At block 211 it is determined whether the allocation requirements are to be used in assistant assignment.

One way to implement the partial articulation workload metrics, and the articulation workload metric, directly is to use them for ranking and scoring of principals in terms of their values. Higher values imply the need for more articulation work support, and therefore justify more administrative assistant support. Higher ranking implies that more priority should be given to apply articulation work support.

If the allocation requirements are to be used, a decision model for assignment can be formulated using the allocation measurements as input parameters 212. The allocation measurements/input parameters include at least the following:

n=Number of assistants
M=Number of principals
xᵢⱼ=Fraction of assistant i to assign to support principal j, for i=1, . . . n, j=1, . . . , m
zᵢⱼ=Binary variable indicating if assistant i supports principal j for i=1, . . . n, j=1, . . . , m
yᵢ=Number of principals supported by assistant I for i=1, . . . n
αⱼ=Required (needed) assistance to principal j, derived from articulation work metrics.
The articulation workload (complexity) metric forms a basis to solve the decision model for assignment 213, using allocation measurements as input parameters, for example:

$${ }^{″} {and}^{″} \{ \begin{matrix}Minimize a cost function f ( all the {x}_{ij} and {y}_{i} variables ) \\ Minimize an efficiency function f ( all the {x}_{ij} and {y}_{i} variables\end{matrix}$$

where the above cost and efficiency functions may be linear or nonlinear. In the nonlinear case, the articulation workload of multiple principals may need more cost and coverage due to increased complexity of, for example, balancing more than one principal schedule when the principals are from different organizations or have different roles, ranks and responsibilities. Another example of nonlinearity is when coverage of more than one principal's articulation workload by a single assistant may be more efficient, due to the assigned assistant's own collaboration network among assistants. In the example decision framework, the above example of objective functions is solved while holding the following example constraints:

### Subject to:

$$0 \leq {x}_{ij} \leq 1 for i = 1 , … , n and j = 1 , … m$$

$${\sum }_{j = 1}^{m} {x}_{ij} \leq 1 for i = 1 , … , n$$

$${\sum }_{i = 1}^{n} {x}_{ij} \geq {α}_{j} for j = 1 , … , m$$

$${z}_{ij} = ceiling ( {x}_{ij} ) for i = 1 , … , n and j = 1 , … m$$

$${y}_{i} = {\sum }_{j = 1}^{m} {z}_{ij} for i = 1 , … , n$$

$${α}_{j} = a function of ( articulation workload of j )$$

$$for j = 1 , … , m$$

A report on ranking of principals by allocation requirements and/or an assignment solution may be generated 214.

The report may be used in combination with a partial articulation workload metric for a plurality of assistants, wherein the partial articulation workload metric of the plurality of assistants may be compared to the partial articulation workload metric of the principal to determine a level of congruence for each of the plurality of assistants, e.g., on a scale from 0-1. A resource allocation requirement of the principal may be determined according to the level of congruence for each of the plurality of assistants, wherein an assistant that has an availability most similar to the allocation requirements of the principal is assigned to the principal.

Exemplary implementations of a method according to the present disclosure include unique product enhancement. A tool and method that can be offered for diagnostics or organizational engineering to other enterprises via a professional services organization, such as consulting. A software module can be embodied as an extension of an existing tool, such as a Lotus Notes extension. For example, an extension can run locally against mail database to capture various fields of each calendar entry over, for example, 12 months (for example, 10 months back, 2 months forward). The extension performs pattern analysis, e.g., for a number of meetings, the types of meetings, a number of invitees, whether travel is needed, the type of travel (e.g., international), revisions to meetings, percentage of free time (flexibility), etc. The extension runs on a target sample of principals' calendars.

According to an embodiment of the present disclosure, a method for allocating articulation workload support increases the efficiency of principals, decreases cost to the organization via elimination of unnecessary administrative support, and provides an empirical foundation for greater objectivity in allocation requirements.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

Referring to FIG. 5, according to an embodiment of the present invention, a computer system 501 for determining resource allocation requirements based on an articulation workload metric can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general purpose computer system that becomes a specific purpose computer system when executing the routine 507 of the present invention.

The computer platform 501 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a method of determining resource allocation requirements based on an articulation workload metric, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for determining an allocation of a workload comprising:
identifying an employee in an organization having the workload;
associating the employee with a partial articulation workload metric; and
determining the allocation of the workload to the employee according to the partial articulation workload metric.

2. The method according to claim 1 further comprising determining the partial articulation workload metric, comprising:
collecting work artifacts for the employee;
recovering input data from the work artifacts;
observing collaborative artifacts from the input data; and
creating the partial articulation workload metric for the employee from the input data and the collaborative artifacts.

3. A method for determining an allocation of a workload comprising:
identifying an employee in the organization having the workload;
associating the employee with an articulation workload metric; and
determining the allocation of the workload to the employee according to the articulation workload metric.

4. The method according to claim 3, further comprising determining the articulation workload metric, comprising:
collecting work artifacts for the employee;
recovering input data from the work artifacts;
observing collaborative artifacts from the input data; and
creating the articulation workload metric for the employee from the input data and the collaborative artifacts.

5. The method according to claim 3, further comprising determining the articulation workload metric, comprising:
collecting work artifacts for the employee;
recovering input data from the work artifacts;
observing collaborative artifacts from the input data;
creating partial articulation workload metrics for the employee and a plurality of collaborators; and
creating the articulation workload metric for the employee from the input data, the partial articulation workload metrics and the collaborative artifacts.

6. The method of claim 3, further comprising:
creating a direct collaboration network including the employee and a plurality of collaborators observed based on the collaborative artifacts; and
reporting the direct collaboration network.

7. The method of claim 6, further comprising handling a request on the employee according to the direct collaboration network.

8. The method of claim 5, further comprising:
creating an overlay network from the partial articulation workload metric of the employee and at least a second partial articulation workload metric of a collaborator.

9. The method of claim 5, further comprising weighting nodes of the overlay network based on the partial articulation workload metrics;
deriving a node articulation workload metric associated with each node of the overlay network; and
converting the node articulation workload metric into an allocation requirement.

10. The method of claim 3, further comprising:
determining a partial articulation workload metric for the employee and a plurality of collaborators;
comparing the partial articulation workload metric of the plurality of collaborators to the partial articulation workload metric of the employee to determine a level of congruence for each of the plurality of collaborators; and
creating the resource allocation requirement of the employee according to the level of congruence for each of the plurality of collaborators.

11. A method for determining an allocation requirement for assigning articulation work comprising:
collecting work artifacts for each of a plurality of employees;
recovering input data from the work artifacts;
observing collaborative artifacts from the input data;
creating a partial articulation workload metric for each employee from the input data and the collaborative artifacts;
creating a direct collaboration network for each employee including a respective employee and a list of unique collaborators relative to the respective employee observed based on the collaborative artifacts;
creating an overlay network from the partial articulation workload metrics of the employees;
weighting nodes of the overlay network based on the partial articulation workload metrics;
deriving a node articulation workload metric associated with each node of the overlay network; and
converting the node articulation workload metric into the allocation requirement for assigning articulation work.

12. The method of claim 11, further comprising:
determining a measure of efficiency for an employee of the plurality of employees; and
assigning the articulation work to the employee according to the measure of efficiency.

13. The method of claim 11, further comprising providing a predetermined list of the plurality of employees.

14. The method of claim 11, further comprising building a target population from an employee of the plurality of employees, wherein the target population includes a subset of the plurality of employees, except the employee, within a predetermined distance in the overlay network from the employee.

15. The method of claim 11, further comprising ranking the employees according to a partial articulation workload metric, an articulation workload metric, or the allocation requirement.

16. The method of claim 11, further comprising assigning a score to the employees according to a partial articulation workload metric, an articulation workload metric, or the allocation requirement.

17. The method of claim 11, further comprising:
building a decision model for the assignment of articulation work, wherein the allocation requirement is a parameter of the decision model; and
outputting the assignment of articulation work from the decision model based on values of the parameters.

18. The method of claim 16, further comprising tuning at least one of a cost function and an efficiency function of the decision model.

19. A method for determining a node articulation workload metric comprising:
collecting work artifacts for each of a plurality of employees;
recovering input data from the work artifacts;
observing collaborative artifacts from the input data;
creating a partial articulation workload metric for each employee from the input data and the collaborative artifacts;
creating a direct collaboration network for each principal including a respective principal and a list of unique collaborators relative to the respective employee observed based on the collaborative artifacts;
creating an overlay network from the partial articulation workload metrics of the employees;
weighting nodes of the overlay network based on the partial articulation workload metrics; and
deriving the node articulation workload metric associated with each node of the overlay network.

20. The method of claim 19, further comprising converting the node articulation workload metric into the allocation requirement for assigning articulation work.
